(19) United States
(12) Patent Application Publication
(10) Pub. No.: US 2008/0079756 A1
(43) Pub. Date: Apr. 3, 2008

(54) DISPLAY DRIVER

(76) Inventors: Akihito Akai, Yokohama (JP); Yasuyuki Kudo, Fujisawa (JP); Yoshiki Kurokawa, Tokyo (JP); Goro Sakamaki, Fuchu (JP); Hiroki Awakura, Yokohama (JP); Naoki Takada, Yokohama (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/779,673

(22) Filed: Jul. 18, 2007

(30) Foreign Application Priority Data
Sep. 29, 2006 (JP) 2006-266147

(51) Int. Cl. G09G 5/10

(52) U.S. Cl. 345/690

(57) ABSTRACT

A liquid crystal driver of liquid crystal display device in which a plurality of expansion/contraction ratios of display data, for example, two kinds of expansion/contraction ratios can be set in a register is provided. Further, the two kinds of expansion/contraction ratios are applicable respectively in two kinds of areas (still-image and video-image) whose coordinates are previously set in a liquid crystal panel. As a result, it is possible to make the still-image area and the video-image area have different expansion/contraction ratios of pixel value respectively. In this manner, it is possible to make display brightness high only in the video-image area, thereby realizing both lower power consumption and visibility improvement at the same time.

### CLAIM OF PRIORITY

The present application claims priority from Japanese Patent Application No. JP 2006-266147 filed on Sep. 29, 2006, the content of which is hereby incorporated by reference into this application.

### BACKGROUND OF THE INVENTION

The present invention relates to a technique for a display driver. More particularly, the present invention relates to a technique effectively applied to backlight control of liquid crystal displays.

For example, most of liquid crystal displays mounted on mobile devices represented by cellular phones are transmissive type and transflective type which need backlights. And, much of the power consumption of the display unit is consumed by its backlight. Thus power reduction of the backlight part achieves long-life battery power for mobile devices. On the other hand, especially for mobile phones, the demand for higher image quality has been getting stronger as well since they have gotten capable of displaying video images, such as television pictures.

As a device for power reduction of backlights, a method is disclosed in Japanese Patent Application Laid-Open Publication No. 11-65531. In the conventional liquid crystal displays, the backlight is continuously emitted at a constant intensity and the amount of light is shielded by a liquid crystal layer to obtain desired display brightness. For example, to obtain display brightness of 80%, the backlight emits 100% and liquid crystal cells before the backlight transmits 80% thereof to obtain the amount of light of 80%. In this case, despite the backlight emits 100%, 20% thereof is lowered by the liquid crystal cells. On the other hand, when the backlight emits 80% and the liquid crystal cells transmits 100%, though the light to be seen is 80%, the emission of backlight can be suppressed to 80%. The difference is utilized to suppress the amount of light emission of the backlight.

In the case where a histogram of pixel values for an image shows the maximum brightness of the pixels with 80% brightness, the backlight emission is lowered to be ⅘ times itself, i.e., lowered to 80% thereof and the pixel values of all pixels are expanded to be 5/4 times itself so that the completely identical image can be displayed with the 80% amount of light.

Further, with utilizing a histogram, pixels ordered in the top several percents are focused. For example, when the brightness of this part is 60%, the amount of light of backlight is suppressed to be ⅗ times itself, i.e., suppressed to 60% thereof and the pixel values of all pixels are expanded to be 5/3 times itself so that the completely identical image can be obtained. In this case, compared to the case where the maximum brightness of the image is utilized, it is possible to realize displaying with further less amount of light.

### SUMMARY OF THE INVENTION

Meanwhile, the method of backlight control disclosed in Japanese Patent Application Laid-Open Publication No. 11-65531 is specialized to achieve low-power consumption of displays. When expanding the display data based on the histogram data, the image may have a part of high-intensity area having no brightness resolution. Therefore, it is required to suppress the expansion ratio of the display data to avoid this image deterioration, and consequently, it has been a problem that the power for backlight cannot be lowered. On the other hand, in the case to view video images such as television pictures, image visibility is rather a problem than above-described image deterioration.

Consequently, an object of the present invention is, focusing the concern on image visibility more than image deterioration when viewing video images so as to solve these problems, to provide a display driver capable of achieving low-power consumption by controlling backlight as well as improving visibility for viewing video images.

The above and other objects and novel characteristics of the present invention will be apparent from the description of this specification and the accompanying drawings.

The present invention achieves setting of a plurality of expansion ratios, e.g., two expansion ratios by a register, instead of applying one expansion ratio to all pixels. Further, the two expansion ratios can be applied respectively to two areas (still image and video image), whose coordinates are previously specified in a liquid crystal panel. As a result, it is possible to have a difference in pixel values between the still image area and the video image area.

According to the present invention, low-power consumption for a display by controlling its backlight is achieved, as well as improving visibility for viewing video images.

### BRIEF DESCRIPTIONS OF THE DRAWINGS

FIG. 1A is an appearance diagram schematically showing a mobile phone of the present invention in which a still-image area and a video-image area are consolidated;

FIG. 1B is a block diagram showing the mobile phone of the present invention in which a still-image area and a video-image area are consolidated;

FIG. 2 is a block diagram showing a configuration of a liquid crystal display according to a first embodiment of the present invention;

FIG. 3A is a block diagram showing a configuration of a backlight control unit of the liquid crystal display according to the first embodiment of the present invention;

FIG. 3B is a table showing a relation between a register value of expansion-ratio setting and an output value X of a decoder unit of the liquid crystal display according to the first embodiment of the present invention;

FIG. 3C is a table showing a relation among selecting data, a display-data expansion ratio of still-image area ‘a’, a display-data expansion ratio of video-image area, and a backlight setting value of the liquid crystal display according to the first embodiment of the present invention;

FIG. 4 is a block diagram showing a configuration of a liquid crystal display according to a second embodiment of the present invention;

FIG. 5A is a block diagram showing a configuration of a control unit of a liquid crystal display according to a third embodiment of the present invention;

FIG. 5B is a table showing a relation between a register value of expansion-ratio setting and an output value Y of a decode unit of the liquid crystal display according to the third embodiment of the present invention;

FIG. 5C is a diagram showing a relation between an x coordinate of a horizontal line crossing a still-image area and a video-image area and a display brightness corresponding thereto of the liquid crystal display according to the third embodiment of the present invention;

FIG. 6A is a block diagram showing a backlight control unit of a liquid crystal display according to a fourth embodiment of the present invention;

FIG. 6B is a table showing a relation between a register value of expansion-ratio setting and an output value Z of a decoder unit of the liquid crystal display according to the fourth embodiment of the present invention; and

FIG. 6C is a diagram showing a relation between an x coordinate of a horizontal line crossing a still-image area and a video-image area and display brightness corresponding thereto of the liquid crystal display according to the fourth embodiment of the present invention.

### DESCRIPTIONS OF THE PREFERRED EMBODIMENTS

Hereinafter, embodiments of the present invention will be described in detail with reference to the accompanying drawings. Note that components having the same function are denoted by the same reference symbols throughout the drawings for describing the embodiment, and the repetitive description thereof will be omitted.

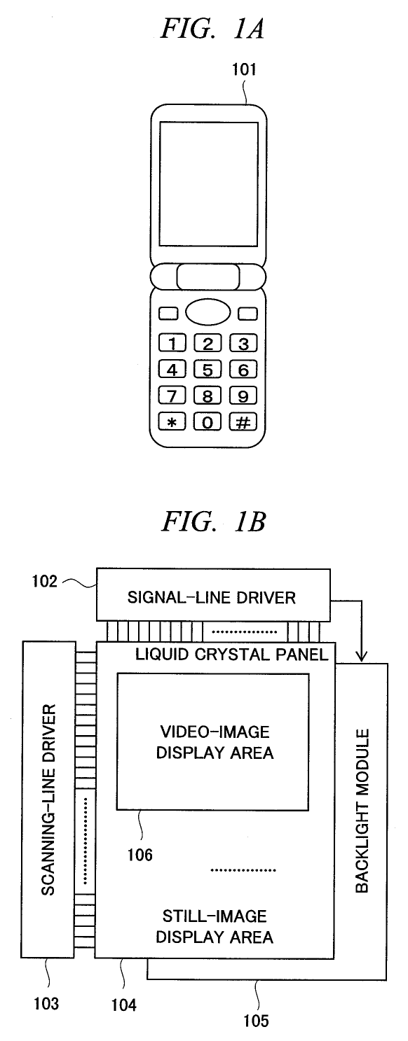

FIG. 1A and FIG. 1B are schematic views showing a mobile phone in which a still-image area and a video-image area are consolidated (FIG. 1A is an appearance diagram, and FIG. 1B is a block diagram). Recently, even a mobile phone 101 has achieved displaying video images like television pictures, in which a still-image display area represented by conventional input displays for phone numbers and characters and a video-image display area for video images represented by telecast and movies may be consolidated. A signal-line driver 102 and a scanning-line driver 103 that drive a liquid crystal panel 104 and a backlight module 105 equally manage data even if it is display data in which the video-image display area 106 and the other still-image display area are consolidated like this. However, video images, for example, movies often are dark image sources generally so the visibility may be worse only in the video-image display area. The present invention aims to take measures against the problem and to achieve both a backlight power-saving function using image histograms and visibility improvement of video images at the same time. Descriptions for respective embodiments will be made concretely as follows.

### First Embodiment

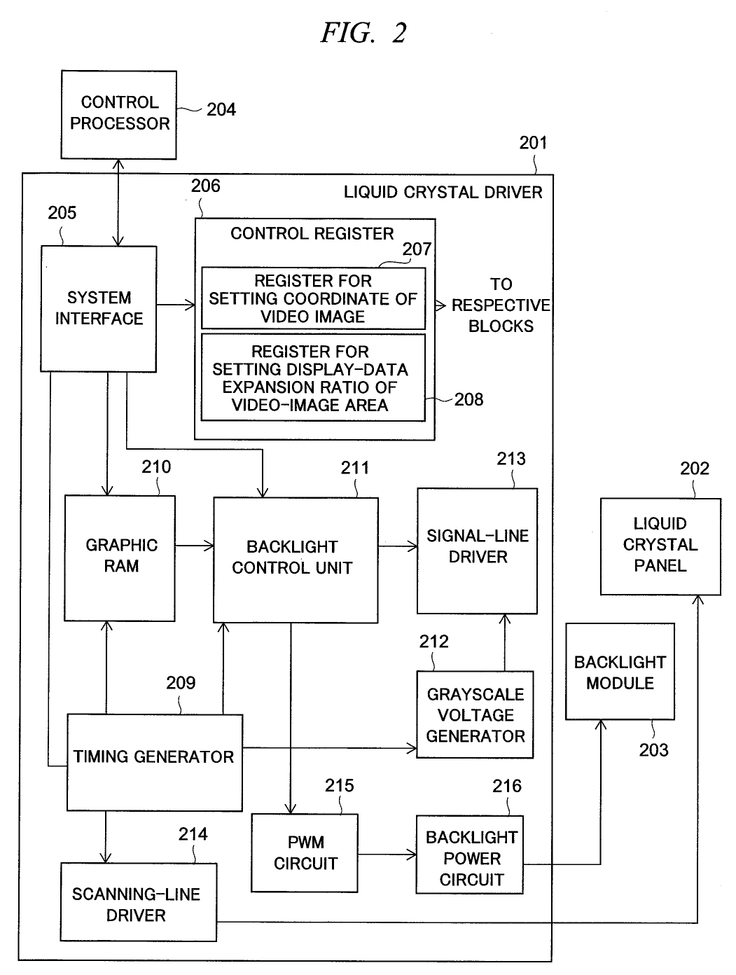

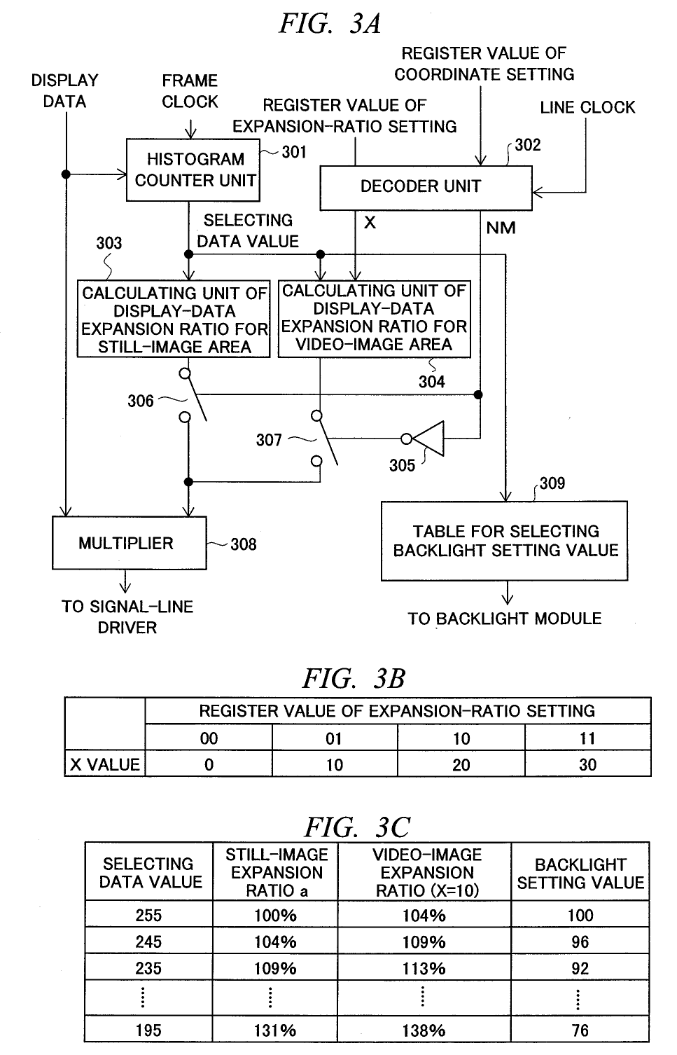

A liquid crystal display according to a first embodiment of the present embodiment will be described with reference to FIG. 2 and FIG. 3.

FIG. 2 is a block diagram showing a configuration of the liquid crystal display according to the first embodiment. In FIG. 2, 201 is a liquid crystal driver, 202 is a liquid crystal panel, 203 is a backlight module, 204 is a control processor, 205 is a system interface, 206 is a control register, 207 is a register for setting coordinate of video image, 208 is a register for setting display-data expansion ratio of video-image area, 209 is a timing generator, 210 is a graphic RAM, 211 is a backlight control unit, 212 is a grayscale voltage generator, 213 is a signal-line driver, 214 is a scanning-line driver, 215 is a PWM circuit, and 216 is a backlight power circuit.

In other words, the liquid crystal display according to the first embodiment comprises: the liquid crystal driver 201; the liquid crystal panel 202; the backlight module 203; and the control processor 204. The liquid crystal driver 201 comprises: the system interface 205; the control register 206 including the register for setting coordinates of video image 207 and the register for setting display-data expansion ratio of video-image area 208; the timing generator 209; the graphic RAM 210; the backlight control unit 211; the grayscale-voltage generator 212; the signal-line driver 213; the scanning-line driver 214; the PWM circuit 215; and the backlight power circuit 216.

The display brightness of the liquid crystal panel 202 is controlled according to a voltage level applied from the liquid crystal driver 201. The liquid crystal panel 202 is, for example, an active-matrix panel in which a TFT is arranged to each pixel and a signal line and a scanning line are wired in matrix thereto.

The liquid crystal driver 201 applies a scanning pulse to the scanning line in the liquid crystal panel 202 in line-sequential to turn the TFT to ON state, and applies a grayscale voltage to a pixel electrode connected to a source terminal of the TFT via the signal line so as to control display grayscale. Note that, an effective voltage value applied to liquid crystal molecules is changed according to the grayscale voltage applied to the pixel electrode so that the display brightness is controlled.

The amount of current flowing in a light-emitting element configuring the backlight determines the amount of light of the backlight module 203. The light-emitting operation is ON/OFF controlled by a pulse signal inputted from, for example, the liquid crystal driver 201.

Next, an operation of each block configuring the liquid crystal driver 201 is described.

The system interface 205 receives an instruction, display data and the like transferred from the control processor 204 and carries out an output operation to the control register 206 described below. Herein, the instruction means information to determine an inner operation of the liquid crystal driver 201, which includes various parameters such as: a frame frequency and the number of driving lines; the number of colors; and the coordinates of video-image area and display data expansion ratio which are features of the present invention.

The control register 203 has a latch circuit embedded therein, and transfers coordinate information of video-image area and a display-data expansion ratio received from the system interface 205 to the backlight control unit 211 described below. Note that, the control register 206 has the register for setting coordinates of video image 207 which holds coordinate information of video-image area and the register for setting display-data expansion ratio of video-image area 208 which holds information of display-data expansion ratio of video-image area.

The timing generator 209 has a dot counter and generates a line clock by counting dot locks. Based on the line clock, a data transfer from the graphic RAM 210 described below to the backlight control unit 211 and output timing of the scanning-line driver 214 are defined.

The graphic RAM 210 stores display data transferred from the system interface 205 and transfers it to the backlight control unit 211 described below.

The backlight control unit 211, which is a block taking a central role of the present invention, receives display data transferred from the graphic RAM 210 and carries out an expansion process on display data to transfer it to the signal-line driver 213 described below.

The grayscale voltage generator 212 generates an analog grayscale-voltage level which realizes displaying a plurality of grayscales.

The signal-line driver 213 takes a role as a DA converter that converts digital display data transferred from the backlight control unit 211 to an analog grayscale-voltage level in a decoder circuit, a level shifter, and a selector circuit embedded therein. The analog grayscale voltage obtained here is applied to the liquid crystal panel 202 so that display brightness thereof is controlled.

The scanning-line driver 214 gets synchronized with a line clock transferred from the timing generator 209 and generates a scanning pulse to be line-sequential with respect to the scanning line in a shift register embedded therein. Further, a level shifter embedded in the scanning-line driver 214 converts a scanning pulse of Vcc-GND level transferred from the above shift register to VGH-VGL level and then outputs it to the liquid crystal panel 202. Note that, VGH is a voltage level to turn the TFT to ON state and VGL is a voltage level to turn the TFT to OFF state.

The PWM circuit 215 modulates a backlight setting value transferred from the backlight control unit 211 to a pulse width. More specifically, it counts dot clocks transferred from the timing generator 209 by a counter embedded therein and compares a counter value and the above backlight setting value in a comparator also embedded therein. In this manner, a backlight control pulse to be a high voltage in a clock period having the same number as the backlight setting value can be generated.

The backlight power circuit 216 converts a backlight control pulse of Vcc-GND level transferred from the PWM circuit 215 to an operating voltage of the backlight module 203 in a level shifter embedded therein. Then, the backlight control pulse after the voltage conversion is inputted to the backlight module 203, and the amount of light thereof is not constant always and is controlled corresponding to display data.

Next, with reference to FIG. 3, a detailed description is given about a configuration and operation in the backlight control unit of the liquid crystal display according to the first embodiment. FIG. 3A is a block diagram showing a configuration of the backlight control unit, FIG. 3B is a table showing a relation between a register value of expansion-ratio setting and an output value X of a decoder unit, and FIG. 3C is a table showing a relation among selecting data, display-data expansion ratio of still-image area ‘a’, a display-data expansion ratio of video-image area, and a backlight setting value of the liquid crystal display.

FIG. 3A is a block diagram showing a configuration of a backlight control unit. In FIG. 3A, 301 is a histogram counter unit, 302 is a decoder unit, 303 is a calculating unit of data expansion ratio for still-image area, 304 is a calculating unit of data expansion ratio for video-image area, 305 is an inverter, 306 and 307 are switches, 308 is a multiplier, 309 is a table for selecting backlight setting value.

The backlight control unit has functions as, particularly, a means for analyzing a histogram of display data for one or a plurality of screens externally inputted and switching the brightness of display image and a means for switching the luminance of backlight based on the value of display data. The histogram counter unit 301 has a function to measure a histogram about display data for one or a plurality of frames and detect a value in histogram corresponding to predetermined display data. Further, the calculating unit of data expansion ratio for still-image area 303, the calculating unit of data expansion ratio for video-image area 304, the inverter 305, the switches 306 and 307, the multiplier 308, and the like configure a display-data converter circuit to expand or contract display data according to the value in histogram which is corresponding to the predetermined display data. Furthermore, the table for selecting backlight setting value 309 and the like realize a means for switching backlight brightness based on the display data value. In the following, functions of each unit are described.

To the histogram counter 301, a frame clock defining a frame period from the timing generator 209 and display data from the graphic RAM 210 are inputted, and the histogram counter 301 creates a histogram by counting display data per unit of frame. Then, the histogram counter 301 calculates a selecting data value to use for carrying out backlight control from the histogram. And the histogram counter 301 transfers it to the calculating unit of data expansion ratio for still-image area 303, the calculating unit of data expansion ratio for video-image area 304, and the table for selecting backlight setting value 309.

To the decoder unit 302, a line clock transferred from the timing generator 209, a register value for setting coordinates transferred from the register for setting coordinates of video image 207, and a register value for expansion-ratio setting transferred from the register for setting display-data expansion ratio for video-image area 208 are inputted. Then, the decoder unit 302 counts the line clock by a counter embedded therein, and, based on the register value of coordinate setting, determines whether display data transferred from the graphic RAM 210 in sync with the line clock is data in the still-image area or in the video-image area. When the data is in the still-image area, a signal NM of 1 “High” is generated, and when the data is in the video-image area, a signal NM of 0 “Low” is generated. Further, the register value of expansion ratio setting is converted to a setting value of expansion ratio X according to, for example, FIG. 3B.

The calculating unit of data expansion ratio for still-image area 303 uses the above-said selecting data to calculate 255÷(selecting data value) so as to calculate the display data expansion ratio for still-image area.

The calculating unit of data expansion ratio for video-image area 304 uses the above-said selecting data value and the X value generated by the decoder unit 302 to calculate 255÷(selecting data value−X) so as to calculate the display-data expansion ratio for video-image area.

The inverter 305 generates an inverted signal /NM of the signal NM generated in the decoder unit 302 and transfers /NM to the switch 307.

The signal NM generated by the decoder unit 302 is inputted to the switch 306, and the switch is turned to ON state by NM=1 “High” and transfers the display-data expansion ratio inputted from the calculating unit of data expansion ratio for video-image area 304 to the multiplier 308.

The signal /NM generated by the inverter 305 is inputted to the switch 307, and the switch 307 is turned to ON state by /NM=1 “High” and transfers the display-data expansion ratio inputted from the calculating unit of data expansion ratio for video-image area 304 to the multiplier 308.

The multiplier 308 carries out a multiplication of display data transferred from the graphic RAM 210 and the display-data expansion ratio. Note that, the display-data expansion ratio herein is a coefficient transferred from the switch 306 when the display data is data in the still-image area (NM=1) or a coefficient transferred from the switch 307 when the display data is data from the video-image area (/NM=1). As a result, the display data in the still-image area is data-expanded by the value generated by the calculating unit of data expansion ratio for still-image area 303, and the display data in the video-image area is data-expanded by the value generated by the calculating unit of data expansion ratio for video-image area 304.

The table for selecting backlight setting value 309 selects an integer value in FIG. 3C indicating the amount of light of the backlight based on the selecting data value transferred from the histogram counter 301. For example, when the selecting data value is 235, the backlight setting value is 92. Note that, the backlight setting value selected here is transferred to the above-said PWM circuit 215, and after it is converted to a backlight control pulse, the amount of light of the backlight module is controlled via the backlight power circuit 216.

According to the configuration and operation described above, visibility of video-image area can be improved, and, since the amount of light can be reduced, lower power consumption and higher quality in video images can be both realized at the same time. More specifically, display brightness gets higher by setting the expansion ratio of pixel value in video-image area larger than that in still-image area, thereby improving visibility. Further, since the amount of light can be reduced similarly as the technique disclosed in Japanese Patent Application Laid-Open Publication No. 11-65531, improvement in visibility and reduction of power consumption can be both achieved at the same time.

Note that, though the liquid crystal display panel was described as an example in the present embodiment, it may be applied to other display devices such as organic EL display. Further, the driver according to the present invention may be that of graphic-RAM embedded type or non-embedded type. Moreover, although it was described that the amount of light of backlight is controlled by the backlight control pulse, it may be controlled by an analog voltage level as long as it can realize the amount of light of backlight to be set in the backlight control unit.

### Second Embodiment

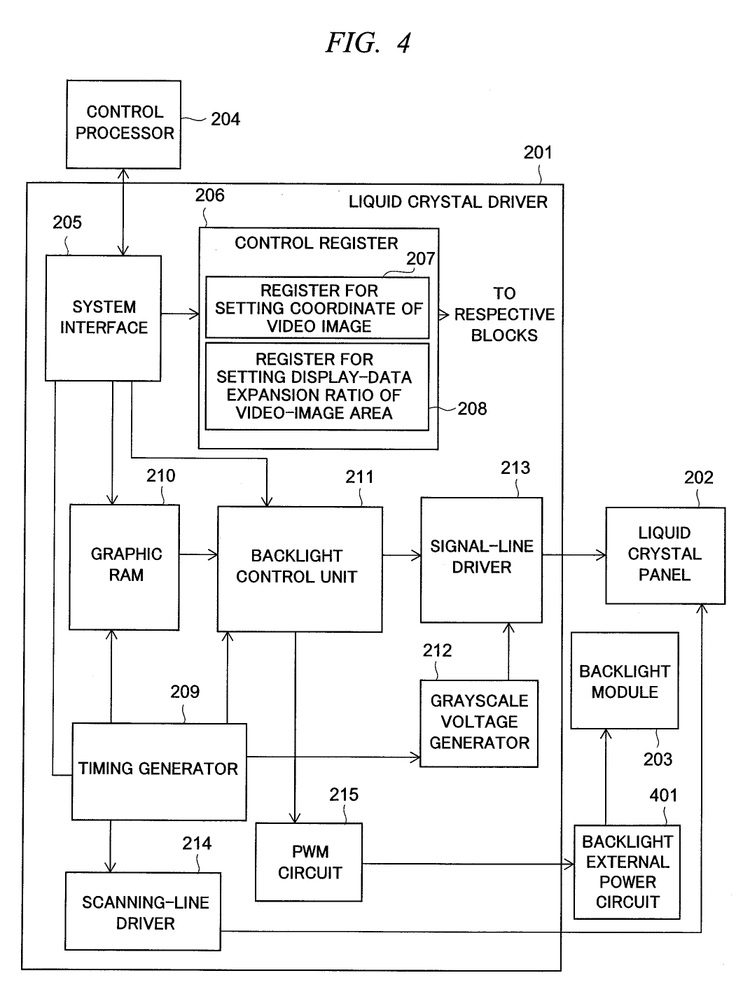

A liquid crystal display device according to a second embodiment is described with reference to FIG. 4. The second embodiment of the present invention comprises a backlight external power circuit 401 used separately with the liquid crystal driver 201, without the backlight power circuit 216 inside the liquid crystal driver 201 of the first embodiment described above.

FIG. 4 is a block diagram showing a configuration of the liquid crystal display device according to the second embodiment of the present invention, and 401 is the backlight external power circuit.

The backlight external power circuit 401 converts a backlight control pulse of Vcc-GND level transferred from the PWM circuit 215 in the liquid crystal driver 201 to an operating voltage of the backlight module 203 by a level shifter embedded therein. Then, the backlight control pulse after the voltage conversion is inputted to the backlight module 203, and the amount of light thereof is not always constant but controlled corresponding to the display data.

Operations of the other blocks are similar to those of the first embodiment described above. Therefore, detailed description thereof is omitted.

According to the circuit configuration and operation described above, similarly to the first embodiment described above, visibility in video-image area can be improved and the amount of light of backlight can be reduced, thereby realizing both lower power consumption and higher image quality of video images at the same time.

Note that, although it was also described that the amount of light is controlled by the backlight control pulse in the present embodiment, it may be controlled by an analog voltage level as long as it can realize the amount of light of backlight to be set in the backlight control unit.

### Third Embodiment

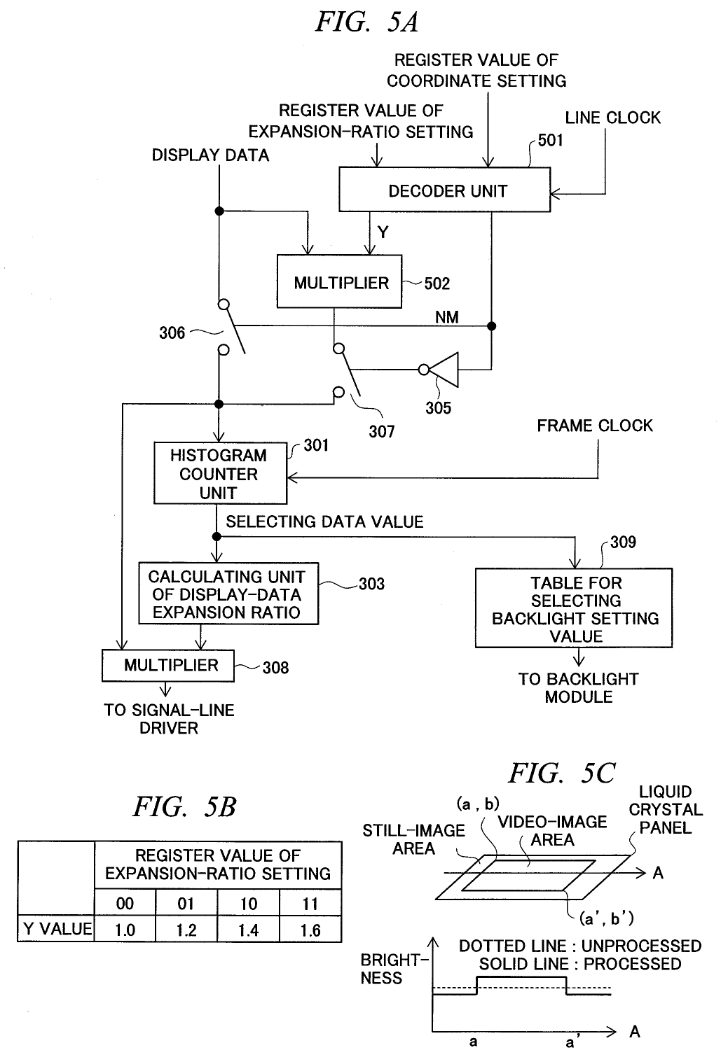

A liquid crystal display device according to a second embodiment is described with reference to FIG. 5. FIG. 5A is a block diagram showing a configuration of the backlight control unit, FIG. 5B is a table showing a relation between a register value of expansion-ratio setting and an output value Y of the decoder unit, and FIG. 5C is a diagram showing a relation between an x coordinate of a horizontal line crossing the still-image area and video-image area and a display brightness corresponding thereto.

The third embodiment of the present invention is the backlight control unit 211 of the first embodiment described above in which the internal configuration thereof is modified. Display data of the video-image area is expanded prior to obtaining histogram data of display data so as to realize lower power consumption by a backlight control.

FIG. 5A is a block diagram showing a configuration inside the backlight control unit 211 in the liquid crystal display device according to the third embodiment of the present invention, and 501 is a decoder unit, 502 is a multiplier, 301 is the histogram counter unit, 303 is the calculating unit of display data expansion ratio, 305 is the inverter, 306 and 307 are the switches, 308 is the multiplier, and 309 is the table for selecting backlight setting value.

To the decoder unit 501, the line clock transferred from the timing generator 209, the register value for setting coordinates transferred from the register for setting coordinates of video image 207, and the register value for expansion ratio setting transferred from the register for setting display-data expansion ratio for video-image area 208 are inputted. Then, the decoder unit 501 counts the line clock by a counter embedded therein, and, based on the register value of coordinate setting, determines whether display data transferred from the graphic RAM 210 in sync with the line clock is data in the still-image area or in the video-image area. When the data is in the still-image area, a signal NM of 1 “High” is generated, and when the data is in the video-image area, a signal NM of 0 “Low” is generated. In addition, the inverter 305 generates a signal /NM which is an inverted signal of the NM. Further, the register value of expansion ratio setting is converted to a setting value of expansion ratio Y according to, for example, FIG. 5B.

The multiplier 502 carries out a multiplication of display data transferred from the graphic RAM 210 and the setting value of expansion ratio Y transferred from the decoder unit 501 described above. Note that, an output of the multiplier 502 and display data unprocessed are selected by the switch 306 and the switch 307 respectively and transferred to the histogram counter unit 301.

The operation is described specifically. When the display data is data in the still-image area, the signal NM becomes 1 “High” and the switch 306 is turned to ON state, and the display data unprocessed is transferred to the histogram counter unit 301. Further, when the display data is data in the video-image area, the signal /NM becomes 1 “High” and the switch 307 is turned to ON state, and the output of the multiplier 502 is transferred to the histogram counter unit 301. In this manner, a data set in which the display data in the still-image area is invariant and only the display data in the video-image area is previously expanded to the direction to which display brightness gets higher is transferred to the histogram counter unit 301. Then, the calculating unit of display-data expansion ratio 303 calculates display-data expansion ratio based on the selecting data value obtained by the histogram counter unit 301. Finally, the multiplier 308 multiplies the display-data expansion ratio and the above-said data set. And the display data accordingly obtained is transferred to the signal-line driver 213.

As shown in FIG. 5C, in the relation of the x coordinate on a horizontal line A crossing the still-image area and video-image area and the display brightness corresponding thereto, the solid line showing the display brightness when carrying out the third embodiment of the present invention is compared to the dotted line showing the display brightness when the display data is not processed. The display brightness between a-a′ which means the video-image area increases compared to the still-image area. Therefore, it is considered to improve visibility. Further, since the third embodiment of the present invention is used in combination with a backlight control technique, lower power consumption and visibility improvement are both realized at the same time. According to the foregoing, similarly to the first embodiment described above, both lower power consumption and improvement in video-image visibility by the backlight control can be realized at the same time.

Note that, although the content of the invention was described referring the relation between the register value of expansion ratio setting and Y value shown in FIG. 5B, this is only an example. And, although it was described that the register value of expansion ratio is 2 bit (4-valued), it can be 1 bit or equal to or more than 3 bit.

### Fourth Embodiment

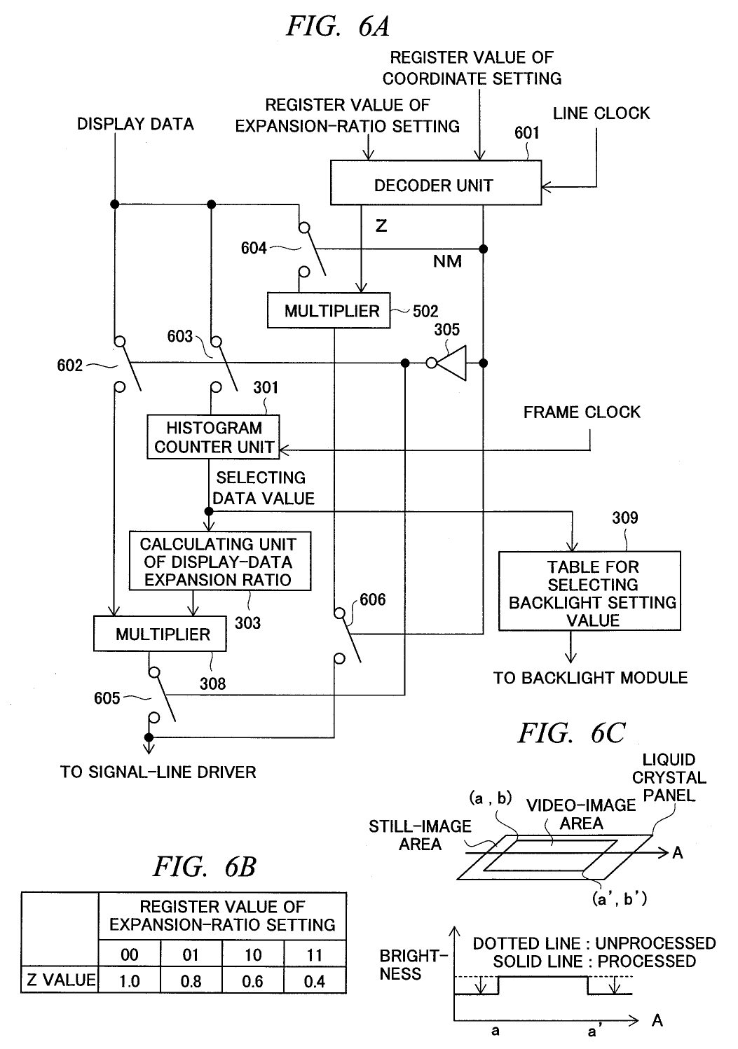

A liquid crystal driver according to a fourth embodiment of the present invention is described with reference to FIG. 6. FIG. 6A is a block diagram showing a configuration of a backlight control unit, FIG. 6B is a table showing a relation between a register value of expansion ratio setting and an output value of decoder unit, and FIG. 6C is a diagram showing a relation between an x coordinate on a horizontal line A crossing the still-image area and video-image area and a display brightness corresponding thereto.

The fourth embodiment of the present invention is the backlight control unit 211 of the first embodiment described above in which the internal configuration thereof is modified. Display data of the still-image area is expanded instead of expanding display data in the video-image area so as to realize an improvement in visibility of video-images.

FIG. 6A is a block diagram showing a modified configuration inside the backlight control unit 211 according to the first embodiment described above. 601 is a decoder unit, 602, 603, 604, 605, and 606 are switches, 502 is the multiplier, 301 is the histogram counter unit, 303 is the calculating unit of display data expansion ratio, 305 is the inverter, 308 is the multiplier, and 309 is the table for selecting backlight setting value.

To the decoder unit 601, the line clock transferred from the timing generator 209, the register value for setting coordinates transferred from the register for setting coordinates of video image 207, and the register value for expansion ratio setting transferred from the register for setting display-data expansion ratio for video-image area 208 are inputted. Then, the decoder unit 601 counts the line clock by a counter embedded therein, and, based on the register value of coordinate setting, determines whether display data transferred from the graphic RAM 210 in sync with the line clock is data in the still-image area or in the video-image area. When the data is in the still-image area, a signal NM of 1 “High” is generated, and when the data is in the video-image area, a signal NM of 0 “Low” is generated. In addition, the inverter 305 generates a signal /NM which is an inverted signal of the NM. Further, the register value of expansion ratio setting is converted to a setting value of expansion ratio Z according to, for example, FIG. 6B.

ON/OFF of the switch 602, the switch 603, and the switch 605 are determined by the signal /NM, and ON/OFF of the switch 604 and the switch 606 are determined by the signal NM. Then, since the signal NM is NM=1 “High” when the display data transferred from the graphic RAM 210 is data in the still-image area, the switch 604 and the switch 606 are turned to ON state, and the display data is transferred to the histogram counter unit 301 and the multiplier 308. Next, the histogram counter unit 301 creates a histogram only by the display data in the video-image area. And, based on the data obtained by this, the calculating unit of display-data expansion ratio 303 outputs a backlight setting value to the PWM circuit 215 and outputs a display data expansion ratio to the multiplier 308. Therefore, the multiplier 308 carries out a multiplication of the display data in the video-image area and the data expansion ratio for the video-image area, and transfers the result to the signal-line driver 213.

As a result, the display data in the still-image area is expanded/contracted in the direction to which grayscale gets darker, and accordingly, the display data in the video-image area gets to have relatively high display brightness. According to the foregoing, similarly to the first embodiment described above, both lower power consumption and improvement in video-image visibility by the backlight control can be realized at the same time.

Note that, in the fourth embodiment of the present invention, a description was given as an example where the display data in the still-image area is expanded/contracted, and a data expansion is carried out so that the display data in the video-image area is equivalent to the case where the backlight control technique is not applied. However, as described in the first embodiment of the present invention, the data expansion ratio of the video-image area may be improved. Further, in the present embodiment, the histogram is created only by the display data in the video-image area, however, histogram may be created by display data of one frame regardless of the display areas. Still further, in the present embodiment, the content of the invention was described by the relation of the register value and Z value shown in FIG. 6B, however, it is only an example. Moreover, although the register value of expansion ratio setting was described as 2 bit (4-valued), it can be 1 bit or equal to or more than 3 bit.

In the foregoing, the invention made by the inventors of the present invention has been concretely described based on the embodiments. However, it is needless to say that the present invention is not limited to the foregoing embodiments and various modifications and alterations can be made within the scope of the present invention.

The present invention achieves visibility improvement of a video-image display while maintaining power saving by a backlight control. The range of application is not limited to displays for mobile phones and it is also applicable to other mobile devices using liquid crystal displays.

What is claimed is:

1. A display driver which analyzes a histogram of externally inputted display data for one or a plurality of screens and switches brightness of displayed image comprising:
a counter which measures the histogram for the one or a plurality of screens and detects a value in the histogram corresponding to predetermined display data; and
a converter circuit which expands or contracts display data corresponding to the value in histogram corresponding to the predetermined display data,
wherein a plurality of kinds of expansion/contraction ratios in the expansion or contraction of display data can be set per one screen.

2. The display driver according to claim 1,
wherein two kinds of the expansion/contraction ratios of display data can be set for one screen,
one of the two kinds of expansion/contraction ratios of display data is an expansion/contraction ratio corresponding to display data in video-image display area, and
the other of the two kinds of the expansion/contraction ratios of display data is an expansion/contraction ratio corresponding to display data in still-image display area.

3. The display driver according to claim 2 comprising a register for externally setting the two kinds of expansion/contraction ratios of display data.

4. The display driver according to claim 2 comprising a register for externally setting one of the two kinds of expansion/contraction ratios of display data,
wherein the other of the two kinds of expansion/contraction ratios of display data is set based on the one of the two kinds of expansion/contraction ratios of display data.

5. The display driver according to claim 1,
wherein the converter circuit comprises: a first calculator of expansion/contraction ratio for a still-image display area; a second calculator of expansion/contraction ratio for a video-image display area; and a multiplier which multiplies the predetermined display data and an expansion/contraction ratio of display data generated by the first calculator of expansion/contraction ratio or the second calculator of expansion/contraction ratio;
display data in still-image display area is expanded/contracted by a value generated by the first calculator of expansion/contraction ratio; and
display data in video-image display area is expanded/contracted by a value generated by the second calculator of expansion/contraction ratio.

6. The display driver according to claim 1,
wherein the converter circuit comprises an expanding/contracting circuit which previously expands/contracts display data in video-image display area prior to obtaining the value in histogram of the predetermined display data;
display data in still-image area is constant; and
display data in video-image area is previously expanded/contracted by the expanding/contracting circuit toward a direction to which display brightness gets high.

7. The display driver according to claim 1,
wherein the converter circuit comprises an expanding/contracting circuit which expands/contracts display data in still-image display area;
display data in still-image area is expanded/contracted by the expanding/contracting circuit in a direction to which grayscale gets dark; and
display data in video-image area gets to have display brightness relatively high with respect to that of the display data in still-image area as a result.

8. A display driver which analyzes a histogram of externally inputted display data for one or a plurality of screens and switches brightness of displayed image comprising:
a counter which measures the histogram for the one or a plurality of screens and detects a value in the histogram corresponding to predetermined display data;
a converter circuit which expands or contracts display data corresponding to the value in histogram corresponding to the predetermined display data; and
a circuit to switch backlight brightness based on the value of display data,
wherein a plurality of kinds of expansion/contraction ratios in the expansion or contraction of display data can be set per one screen.

9. The display driver according to claim 8,
wherein two kinds of the expansion/contraction ratios of display data can be set for one screen,
one of the two kinds of expansion/contraction ratios of display data is an expansion/contraction ratio corresponding to display data in video-image display area, and
the other of the two kinds of the expansion/contraction ratios of display data is an expansion/contraction ratio corresponding to display data in still-image display area.

10. The display driver according to claim 9 comprising a register for externally setting the two kinds of expansion/contraction ratios of display data.

11. The display driver according to claim 9 comprising a register for externally setting one of the two kinds of expansion/contraction ratios of display data,
wherein the other of the two kinds of expansion/contraction ratios of display data is set based on the one of the two kinds of expansion/contraction ratios of display data.

12. The display driver according to claim 8,
wherein the converter circuit comprises: a first calculator of expansion/contraction ratio for a still-image display area; a second calculator of expansion/contraction ratio for a video-image display area; and a multiplier which multiplies the predetermined display data and an expansion/contraction ratio of display data generated by the first calculator of expansion/contraction ratio or the second calculator of expansion/contraction ratio;
display data in still-image display area is expanded/contracted by a value generated by the first calculator of expansion/contraction ratio; and
display data in video-image display area is expanded/contracted by a value generated by the second calculator of expansion/contraction ratio.

13. The display driver according to claim 8,
wherein the converter circuit comprises an expanding/contracting circuit which previously expands/contracts display data in video-image display area prior to obtaining the value in histogram of the predetermined display data;
display data in still-image area is constant; and
display data in video-image area is previously expanded/contracted by the expanding/contracting circuit toward a direction to which display brightness gets high.

14. The display driver according to claim 8,
wherein the converter circuit comprises an expanding/contracting circuit which expands/contracts display data in still-image display area;
display data in still-image area is expanded/contracted by the expanding/contracting circuit in a direction to which grayscale gets dark; and
display data in video-image area gets to have display brightness relatively high with respect to that of the display data in still-image area as a result.
